(19) United States
(12) Patent Application Publication
(10) Pub. No.: US 2013/0060935 A1
(43) Pub. Date: Mar. 7, 2013

(54) SYSTEM AND METHOD FOR CREATING A DATA DISPLAY TO MONITOR STATUS OF A RELATIONSHIP BETWEEN TWO INDIVIDUALS

(71) Applicant: Zuhairah Y. SCOTT WASHINGTON, Washington, DC (US)

(72) Inventor: Zuhairah Y. SCOTT WASHINGTON, Washington, DC (US)

(21) Appl. No.: 13/601,577

(22) Filed: Aug. 31, 2012

Related U.S. Application Data
(60) Provisional application No. 61/530,182, filed on Sep. 1, 2011.

(51) Int. Cl. G06F 15/173

(52) U.S. Cl. 709/224

(57) ABSTRACT

Embodiments of the invention include a system and method for monitoring status of a relationship between two individuals. Using a computer network or mobile network, the two individuals in the relationship create profiles, each profile including a sub-profile of input variables. These customizable input variables correspond to behavior conducive to the relationship. The first individual enters data by tallying observed behaviors of the second individual corresponding to each particular input variable, and the second individual enters data by tallying observed behaviors of the first individual corresponding to each particular input variable. A visual representation is displayed based upon the entered data and the sub-profile. The system is presented on a mobile device of each individual connected to a network, so that each individual can easily enter data, view the display, and monitor status of the relationship. Status, reminder, tips, rewards, comments, and notifications are additional parts of the invention.

### RELATED U.S. APPLICATIONS

The present application claims priority under U.S. Code Section 119(e) from a provisional patent application, U.S. Patent Application No. 61/530182, filed on 1 Sep. 2011 and entitled “SYSTEM AND METHOD FOR CREATING A DATA DISPLAY TO MONITOR STATUS OF A RELATIONSHIP BETWEEN TWO INDIVIDUALS”.

### STATEMENT REGARDING FEDERALLY SPONSORED RESEARCH OR DEVELOPMENT

Not applicable.

### REFERENCE TO MICROFICHE APPENDIX

Not applicable.

### BACKGROUND OF THE INVENTION

1. Field of the Invention

The present invention relates to creating a data display. Particularly, the present invention relates to a system and method for creating a data display based upon active inputs from two individuals within a common set of variables. More particularly, the present invention makes a mobile software app to monitor the status of a romantic relationship between two individuals.

2. Description of Related Art Including Information Disclosed Under 37 CFR 1.97 and 37 CFR 1.98.

Online tools to find a relationship are known, and online dating is now a common way for individuals to make contact and communicate with each other over the Internet or mobile network, usually with the objective of developing a personal romantic or sexual relationship. These dating services usually provide matchmaking through the use of personal computers or cell phones.

The known dating services typically require an individual to complete a profile of personal information, including but not limited to biographical data, personal tastes, and relationship objectives. Then, each registered individual can search the compiled database for other individuals, according to criteria set by the searching individual. For example, age range, gender and location are common search criteria. There are options to include status updates, photos, music interests, and other criteria. The dating services may even offer more extensive social networking through webcasts, online chat, telephone chat, and message boards. Many sites have become more specific, targeting a certain ethnic group or other background, such that registered members all share a common trait or interest.

In the past, various patents have been issued relating to devices to online tools for romantic relationships. For example, U.S. Pat. No. 6,735,568, issued to Buckwalter, et al. on May 11, 2004, discloses a method and system for identifying people who are likely to have a successful relationship. The method is a matching service that approximates the relationship satisfaction of a user and identifies candidates for a relationship with the user based on the approximated satisfaction. The matching service provides a plurality of communication levels at which the parties can communicate. Each communication level allows the parties to exchange information in a different format. The parties are permitted to exchange information at one of the communication levels.

U.S. Pat. No. 6,665,389, issued to Haste, III on Dec. 16, 2003, teaches an anonymous interactive internet-based dating service. The service allows people to anonymously interact via Internet browsers, telephone communications and/or video conferencing. People can communicate to determine compatibility for a relationship, as well as block individuals from contact, such that a particular display of profiles is no longer able to be viewed.

The features of the online dating services have included additions, such as cell phone compatibility and online diaries. U.S. Pat. No. 7,907,149, issued to Daum on Mar. 15, 2011, describes a system and method for connecting people based on a cell phone network. The method uses telecommunication in the form of phones, cell phones or email. Information between two people is exchanged by the Internet or telephone or cell phones.

U.S. Pat. No. 7,917,448, issued to Smola, et al. on Mar, 29, 2011, describes an apparatus and method for online dating service providing threaded messages with a notes and diary function. There is a message center for communicating messages between candidates. The messages in the message center are organized as threads. The message center creates a diary or log or feed, regarding online dating service activities.

Additionally, the visual display of a user has been modified according to responses and input into the service. U.S. Pat. No. 7,882,039, issued to Weiss, et al. on Feb. 1, 2011, teaches a system and method of adaptive personalization of search results for online dating services. The visual display is altered according to adaptive personalizations from a user's activities. Based on responses to questions, a user's display is modified to only include compatible user profiles, according a subscore. Subscores represent various user activities, affinities with a candidate, frequencies of viewing a candidate profile, and feedback about a candidate from the user.

U.S. Pat. No. 7,269,590, issued to Hull, et al. on Sep. 11, 2007, teaches a method and system for customizing views of information associated with a social network user. The visual display of the user is set according to user-defined criteria based upon the user's relationship with each prospective viewer. The user-defined criteria may include different variables, such as degrees of separation, common activity interests, and relationship to the prospective viewer. The user-defined relationship criteria is mapped according to the social network, so that the view of the user is personalized.

Importantly, online tools to maintain a relationship are very limited in comparison to these prior art online tools to find a relationship. Once a connection is made, the current online dating services are no longer involved. Maintaining a relationship between two users, who know each other, is significantly different from matching anonymous users or new users. Users in a relationship can be better coordinated for entering data and more compliant with participation. The resources of an online tool can be expanded with cooperative game play models, instead of only individual driven models to find a match. Active online tools strengthen an existing relationship by encouraging participation and communication beyond online interactions. Besides social networks with status updates and linked profiles, there are no equivalent online interactive tools for married or similarly committed couples as the present invention.

It is an object of the present invention to provide a method to monitor status of a relationship between two individuals.

It is an object of the present invention to provide a mobile smartphone app to monitor status of a romantic relationship.

It is an object of the present invention to provide a computer program, which applies gaming principles to encourage positive behavior change of individuals in a romantic relationship.

It is another object of the present invention to provide a method to maintain a romantic relationship by increasing communication between two individuals in a relationship.

It is another object of the present invention to provide a method to maintain a romantic relationship by increasing cooperation between two individuals in a relationship.

It is still another object of the present invention to provide a method to maintain a romantic relationship by receiving feedback for romantic behavior.

It is still another object of the present invention to provide a method to maintain a romantic relationship by increasing thinking and writing about the relationship.

It is an object of the present invention to provide a method to maintain a romantic relationship by allowing positive affirmations between the two individuals in the relationship and active promotion of positive behavior change.

It is another object of the present invention to provide a method to maintain a romantic relationship by self-tracking and self-monitoring of behaviors performed in the development and progress of the relationship by an individual, including setting and meeting goals for the relationship.

These and other objects and advantages of the present invention will become apparent from a reading of the attached specification.

### SUMMARY OF THE INVENTION

Embodiments of the invention include a system and method for monitoring status of a relationship between two individuals. Using a computer or mobile network, the two individuals in the relationship create profiles. Each profile comprises personal information. The profiles of the two individuals in the relationship are associated to each other and are secured with password protection. Each profile also includes a sub-profile of input variables. These input variables correspond to behaviors conducive to a healthy relationship. The input variables can be customized between and by the two individuals. The relationship may be a romantic relationship or other type of relationship. Each sub-profile ranks or weights the input variables according to individual preferences. Certain input variables can be weighted as more important to an individual than another input variable.

In the embodiments of the invention, the first individual enters observed behaviors of the second individual as entered data, including classifying each observed behavior as related to at least one input variable, and the second individual enters observed behaviors of the first individual as entered data, including classifying each observed behavior as related to at least one input variable. Each individual can only give positive reinforcement for the other individual. The entered data can correspond to the health of the relationship because positive behaviors are indicators of a healthy relationship as determined by each individual. Whether a relationship is healthy and fulfilling is set by each individual in a respective sub-profile. Additionally, the individuals can enter other peripheral data, such as sharing comments, status, and mood.

The entered data and input variables of the sub-profile are used to create a display for the individuals to visually inspect. The display reflects status of the relationship as determined by the entered data and the weighted input variables in the sub-profile. The entered data can be compiled with different parameters, such the data entered within a particular time period. This compiled data and the sub-profile can be used to generate the visual representation. Selecting a time period as a parameter can maintain display of the visual representation as current and updated. The entered data by each individual is displayed on the mobile device of the other individual connected to the computer network. The first individual views a display formed by the entered data from input variables as entered by the second individual and by the weight of the input variables as ranked by the first individual. Conversely, the second individual views a display formed by the entered data from input variables as entered by the first individual and by the weight of the input variables as ranked by the second individual. Thus, each individual can easily monitor the status of the relationship through a visual representation. Additionally, the sub-profile can also be part of the visual display so that an individual may view a comparison between the entered data and the weighted input variables of the sub-profile of the individual. The display may be comprised of a meter image, graph display, or badge images for collection by each individual.

The entered data can be compiled data or stored data or both. The compiled data is entered data defined by a specific parameter, such as a set amount of time. The compiled data for the set amount of time, such as the immediate past month, can be used to determine the visual representation. The entered data can also become stored data for tracking relationship history or compiled for reward and marketing purposes. A “re-set” is actually a set of new compiled data, which can determine a new or updated visual representation. The individuals may also change the ranking of the input variables for another re-calculation of the display.

Embodiments of the invention further include communication to the individuals across the computer or mobile network, such as comments, status information, reminders, and tips. The invention may also dispense rewards and notifications to individuals achieving desired goals for entered data and display of a healthy relationship status. The rewards may be linked to vendors for coupons and discounts to dining and entertainment services of the vendors. Embodiments of the invention may also include maintaining non-romantic relationships, such as an employer-employee relationship to monitor job performance and satisfaction, a parent-child relationship to monitor family bonding, student-teacher relationship to monitor education and development goals, or even applying the invention in a counseling or therapy context or exercise.

The system is the computer or mobile network of a server and devices, like computer terminals and smartphones, which supports the social network of the association of the two individual profiles. The server includes a processor, a communications interface, and a memory for storing profiles, data, and sub-profiles. The devices correspond to individuals, whether each profile is managed from a computer or smartphone.

### BRIEF DESCRIPTION OF THE DRAWINGS

FIG. 1 is a schematic view of the system of the present invention, showing devices, including a computer terminal and a smartphone.

FIG. 2 is a schematic illustration of an opening menu screen of a mobile phone app, showing the system and method for monitoring the status of a relationship between two individuals of the present invention. The relationship in the example is a romantic relationship, although other types of relationships are also eligible for the present invention.

FIG. 3 is a schematic illustration of a Settings menu screen of a mobile phone app, showing the profile of an individual in the system and method of the present invention.

FIGS. 4A and 4B are schematic illustrations of personal information screens of a mobile phone app, showing examples of personal information of the profile of an individual in the system and method of the present invention.

FIG. 5 is a schematic illustration of a sub-profile menu screen of a mobile phone app, showing the input variables in the system and method of the present invention. The input variables can be customized by the two individuals, and the input variables can be related to a romantic relationship or other type of relationship.

FIG. 6 is a schematic illustration of a Kudos menu screen of a mobile phone app, showing entered data in the system and method of the present invention.

FIG. 7 is a schematic illustration of a Badges menu screen of a mobile phone app, showing one type of visual representation as a badge in the system and method of the present invention.

### DETAILED DESCRIPTION OF THE DRAWINGS

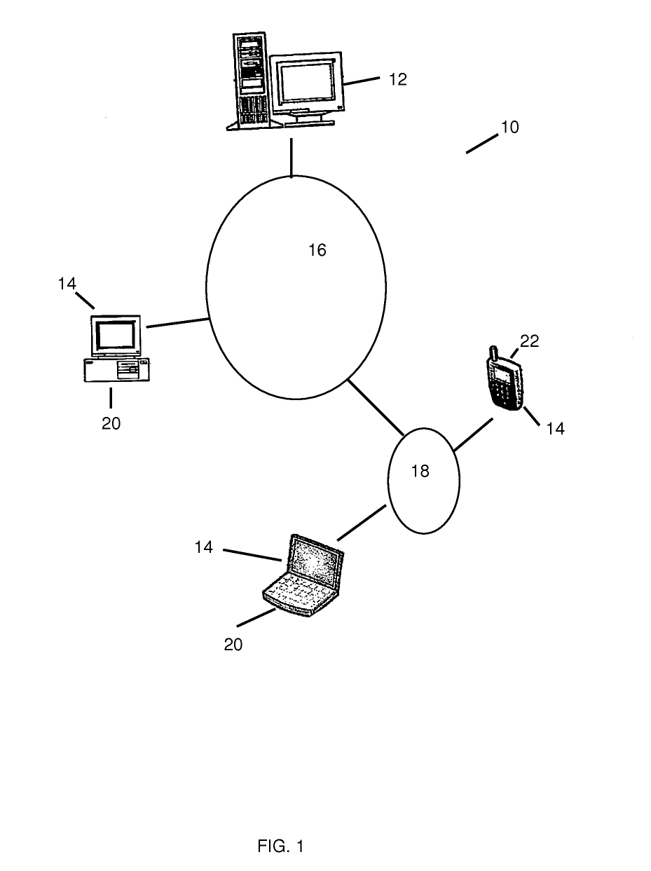

Embodiments of the present invention include a system for monitoring status of a relationship between two individuals. FIG. 1 shows a schematic illustration of the system 10. The system 10 has a server 12 comprising a processor, a communications interface, and a memory for storing an individual profile, and a plurality of devices 14, corresponding to individuals of each profile. Each of the two individuals in the relationship creates profiles, and these profiles are linked to each other. Any device 14 is configured to connect to a computer network 16 or a wireless network 18, wherein the wireless network connects to the computer network 16, and wherein either individual may use the device 14 to access their corresponding profile. The present invention may include a computer network 16 or a mobile communications network. FIG. 1 shows the devices 14 as computer terminals 20 and as smartphones 22. The server 12 maintains the profiles and processes the input from each individual using a device 14. The computer terminals 20 and smartphones 22 can be the user interface for either individual to access respective profiles. The first individual enters data for input variables on the device 14 of the first individual, which may be a smartphone 22. The second individual enters data for the input variables on the device 14 of the second individual, which may also be a smartphone 22. Additionally, the devices 14 provide a visual presentation of profile, data and sub-profile of the other individual.

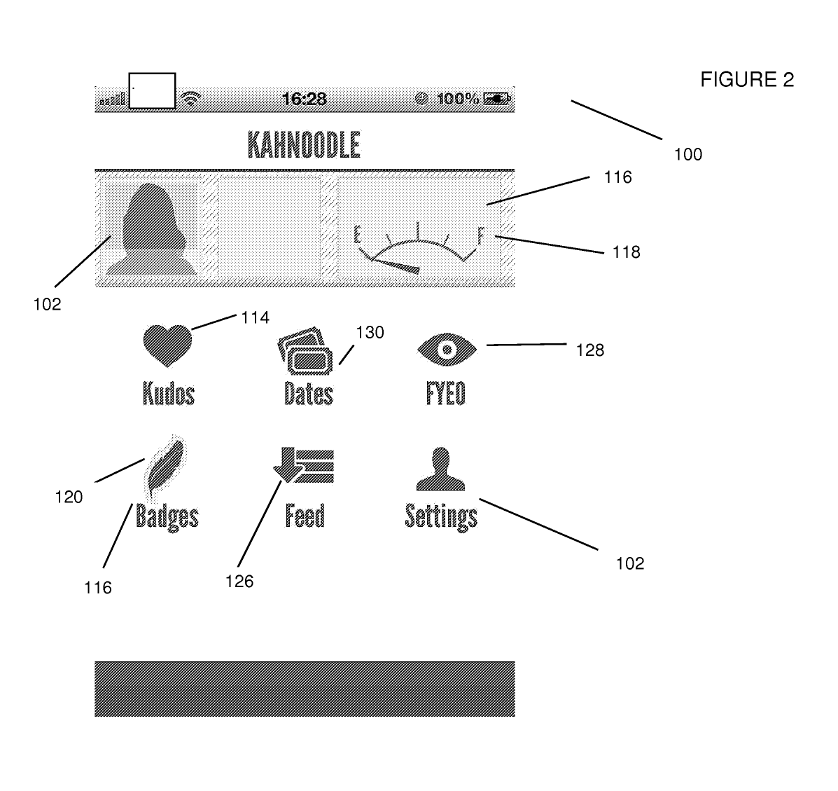

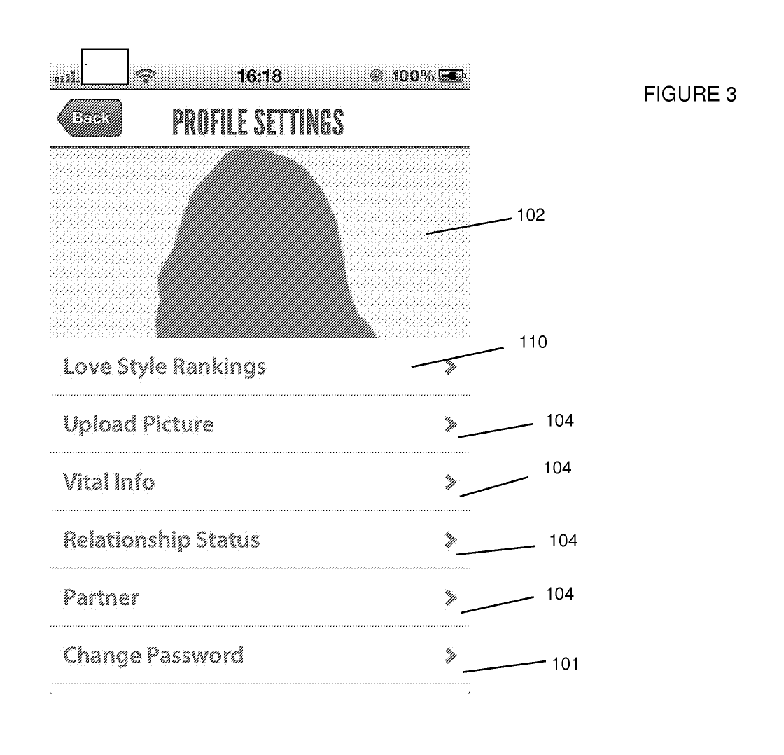

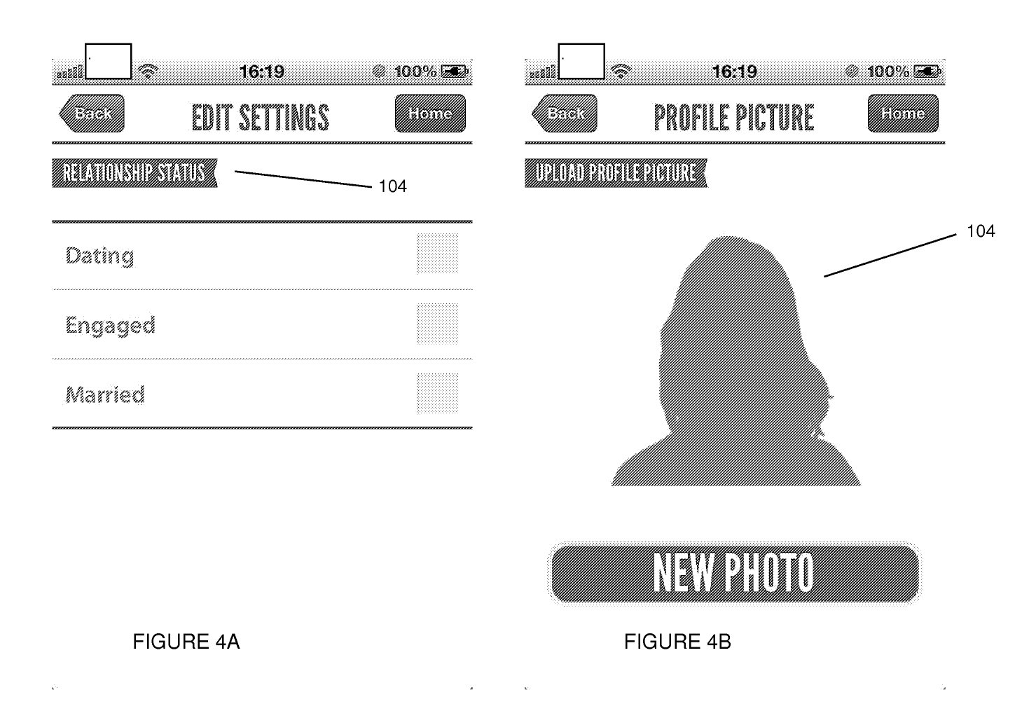

An embodiment of the present invention further includes the method for monitoring status of a relationship between two individuals. The method includes maintaining a first individual profile by a first individual in a computer network 16 and a second individual profile by a second individual in the same computer network 16. The profile comprises personal information, and the first and second individual profiles are associated with each other, just as the two individuals are in the relationship. The associated profiles allow for game play as a coordinated pair within the system and method of the present invention. Each profile is secured with password protection for access only by the respective individual, who created the profile from any device 14. FIGS. 2 and 3 show a schematic 100 of the present invention with a profile 102 comprised of personal information 104. FIGS. 2 and 3 involve an embodiment for a romantic relationship, although other types of relationships can also work in the present invention. A password or login 101 restricts access. The personal information 104 of the profiles may comprise photos, preference information, relationship status, partner identification, password setting, and a login settings and possibly notification settings, such as email alerts. FIGS. 4A and 4B show the photo upload as personal information 104 and relationship status as personal information 104, respectively. Additionally, each profile 102 can have sharing options (not shown) by a social network or emails. There is also an optional display setting (not shown) to allow viewing by a third individual with a third profile, which can be a particular type of sharing option. Each profile 102 may also include a storage option (not shown) to allow compilation of data entered by the individuals in the present invention 100. For example, a mobile app can include an opening menu screen with a “Settings” 102 tab in FIG. 2. The “Settings” tab brings the user to a settings menu screen with “Love Style Rankings” 110, “Upload Picture” 104, “Vital Info” 104, “Relationship Status” 104, and “Partner” 104 tabs in FIG. 3. The settings menu screen may also include a “Password” tab 101 to access the password settings of the user. The Upload Picture, Vital Info, Relationship Status, and Partner tabs access the personal information 104. The individual uses those tabs to enter and change the personal information 104.

As personal information 104 as shown in FIGS. 3, 4A and 4B, preference information includes clothing size requirements, birthday dates, and other personal preference data, such as anniversary dates or favorite colors. The personal information 104 becomes reference tool for relevant information about the individuals in the relationship. As tastes change, the personal information 104 can be updates. As milestone events occur for the couple, the personal information 104 can be added to enhance the communication and harmony between the first and second individuals.

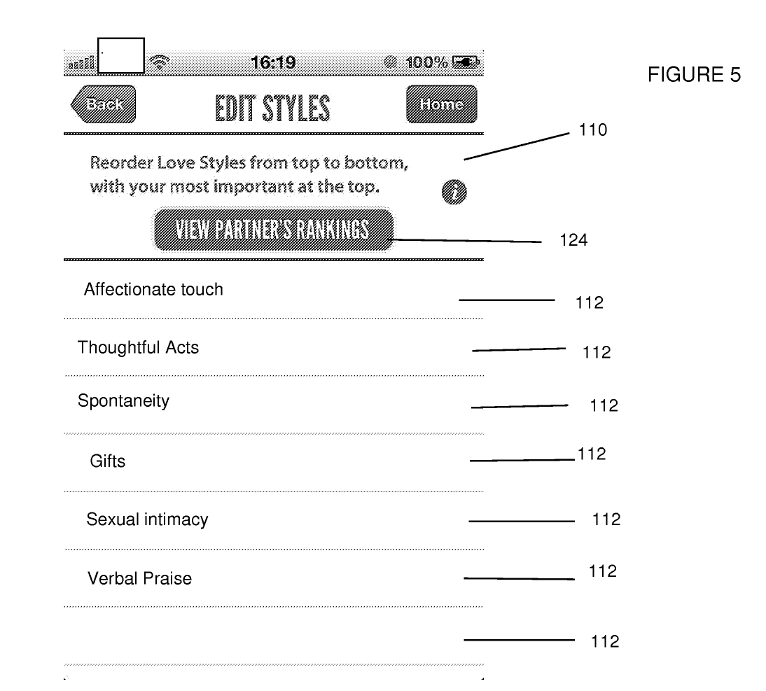

Embodiments of the invention further include maintaining a sub-profile 110 for each profile 102 in FIGS. 3 and 5. Each sub-profile 110 is comprised of input variables 112. Input variables 112 can be associated with behaviors relevant to the relationship between the two individuals. For example, if the two individuals form a married couple, then the input variables 112 can be romantic behaviors, such as affectionate touch, thoughtful acts, spontaneity, quality time, gifts, verbal praise, sexual intimacy. The input variables 112 can be customized and set by the two individuals in the relationship. The input variables 112 will be the same for the associated individuals, and each set of individuals may have a personalized set of input variables. Determining the input variables 112 allows the present invention to function for different types of relationships, such as parent-child, employee-employer, and student-teacher.

Importantly, each individual ranks the importance of each input variable 112, giving certain input variables 112 greater weight. In the example of the married couple, the first individual may weigh quality time and sexual intimacy over gifts and spontaneity to create their sub-profile 110. The second individual will also be able to weigh the input variables 112 for their own sub-profile 110. As such, the sub-profile 110 of the first individual is comprised of a set of weighted input variables 112 by the first individual, and the sub-profile 110 of the second individual is comprised of a set of weighted input variables 112 by the second individual. The sub-profiles 110 can be updated and amended in the present invention 100 so as to encourage discussion and communication and progression of each individual in the relationship. For the mobile app example, the settings menu screen includes a “Love Style Rankings” tab, corresponding to the sub-profile 110 in FIGS. 3 and 5. Accessing the “Love Style Rankings” tab 110 brings the user to the styles menu, which lists the “Love Styles” input variables 112, such as affectionate touch, thoughtful acts, spontaneity, quality time, gifts, verbal praise, sexual intimacy. The individual can enter the data to set the rankings and weight of these love styles as input variables 112. The styles menu 110 may also include a link to view the styles menu of the partner of the individual, with access to the rankings and weights of the partner.

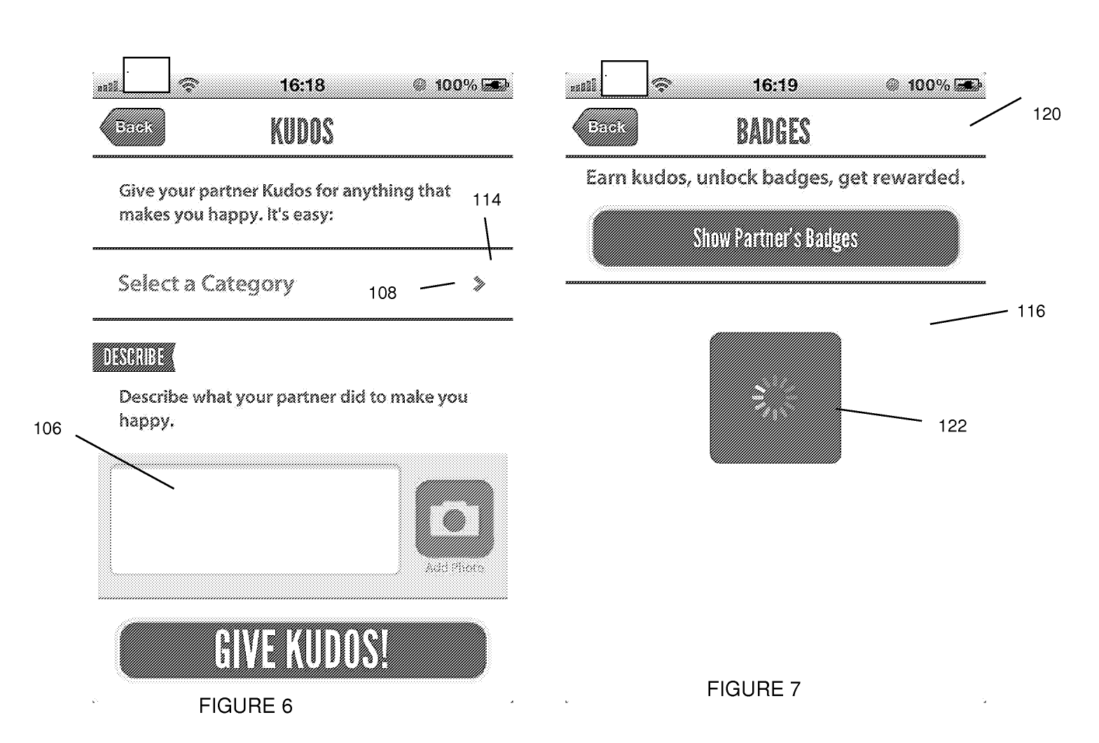

An embodiment of the method of the invention further includes entering data 114 into the profiles 102 by each individual as shown in FIG. 6. The step of entering data comprises tallying each behavior corresponding to an input variable 112. The first individual enters data 114 for each behavior performed by the second individual, and the second individual enters data 114 for each behavior performed by the first individual. The tally is only positive, such that the positive behaviors conducive to strengthening the relationship are counted. Only behaviors of the second individual recognized and entered by the first individual are entered. Only behaviors of the first individual recognized and entered by the second individual are entered. The entered data includes the behavior 106 and selection 108 of the input variable 112 corresponding to the behavior. In this manner, communication between the individuals is encouraged by the gaming principle of the present invention, especially if there is data to support lack of recognition and acknowledgment between the individuals in the relationship. The linked profiles 102 of the present invention 100 allow for the cooperative game play with two willing and coordinating individuals in the system. The feedback between the two individuals is visually presented so that monitoring the behaviors or lack of behaviors becomes easier to detect and recognize. For the mobile app example, the opening menu screen in FIG. 2 can include a “Kudos” tab 114, which leads to a kudos menu in FIG. 6. The kudos menu 114 includes the data entry screen for entering the text description of the observed behavior 106 and for selecting 108 which love style or input variable 112 applies to the observed behavior.

The invention further includes displaying data 116 of the first individual to the second individual and displaying data 116 of the second individual to the first individual in FIGS. 2 and 7. The step of displaying data 116 is coordinated with the sub-profile 110 of each individual. For example, a visual representation of the data for each behavior of input variables 112 performed for the second individual by the first individual is displayed to the first individual, such as a graph, chart, circle diagram, or badge image. For the mobile app example in FIG. 2, the opening menu screen includes a “Love Tank Meter” 118, similar to a gas tank meter for a motor vehicle with an dial rotatable from “E” for empty to “F” for full. The meter 118 is a visual display 116 of the amount of matching between the kudos entered and ranking of styles; that is, the entered data 114 matching the desire and ranked hierarchy of the sub-profile 110 of the other individual. More kudos for a particular love style results in a better reading of the love tank meter, although all kudos for all love style generate the particular love tank meter reading. More entered data 114 in a highly ranked input variable 112 results in a better visual display 116.

The visual display 116 is the generated result of the present invention to monitor the health of the relationship. The first individual can view the number of behaviors performed in the input variables 112 for the second individual. In another embodiment of the visual display 116 in the mobile app in FIG. 7, there the badge image 122. For example, a particular badge image 122 may be associated with a particular input variable 112. Good performance with that particular input variable results in a badge image display to the proper individual in the relationship. Similarly, the second individual can view the number of input variables 112 performed for the first individual. All of the kudos entered for a particular love style may be rewarded with a badge image 122 corresponding to that love style. The entered data 114 for an input variable 12 can result in a badge image 116 as the visual display. In the mobile app example, the opening menu screen can include a “Badges” tab 120 in FIG. 2, leading to a badges screen, which displays the badge images 122 earned by the individual in FIG. 7.

The present invention includes alternative visual displays 116. In particular for the mobile app, the styles menu can link to the styles menu of the partner of the individual. Also, the step of displaying further comprises providing a visual representation of the sub-profile 110 of the first individual to the second individual and the data for each behavior of the second individual; that is, the love tank meter of the partner of the individual may be viewable by a link on the opening menu screen. The link 124 is shown in FIG. 5. In this manner, the second individual can view a display of whether performed behaviors of the input variables 112 for the first individual match the importance of the weighted input variables 112 of the first individual. The game play of the present invention allows for the first individual and the second individual to cooperate with monitoring the relationship together.

Similarly, the first individual can view a display of whether performed behaviors of the input variables 112 for the second individual match the importance of the weighted input variables 112 of the second individual. This display may be a graph or chart image. Thus, the present invention provides a clear visual representation of whether the relationship needs of the individual are being met by the other individual in the relationship. The badge image 122 can also be adapted for this display of matching weighted input variables 112. A badge image for a particular input variable 112 can be presented to the first individual when the second individual has tallied enough behaviors of the first individual in that particular input variable. The visual presentation facilitates the self-monitor and self-tracking objectives of the present invention because the status of the relationship can be viewed. Achievement is determined by the weighted input variables and the tallied behaviors entered by the individuals. Additionally, setting and meeting goals for the relationship can be visually presented to assist in maintaining the relationship, romantic or otherwise.

For example, if gifts are the most important input variable to the first individual, then the display will show a large representation of the input variable of gifts to the second individual. The entered data 114 for performed behaviors of gifts will be shown juxtaposed to the large representation. The second individual will be able to quickly monitor the status of satisfying the first individual in this aspect of the relationship.

Another embodiment of the present invention 100 includes a visual presentation as a feed image 126 in FIG. 2. A chronological history of entered data can also be presented in a feed image format, such as a blog posting or message board or comment board visual presentation. Text content is a feed image that can also serve as the visual presentation of displaying data. In the mobile app example, the opening menu screen may include a “Feed” tab 126, which links to the visual presentation of the comments and kudos 114 entered by either the first individual or the second individual.

Still another embodiment of the present invention includes compiling the entered data 114 by different parameters. The entered data 114 can become compiled data to determine the visual representation 116. For example, the compiled data may be the entered data 114 for a set period of time, such as every month. The tally of performed behaviors in each input variable 112 is compiled according to these parameters of the set period, so that the status of the relationship remains current and active in the visual representation 116. For the mobile app example in FIG. 2, the Love Tank Meter 118 must be current in order to provide the status of the relationship. The Love Tank Meter 118 can be based upon compiled data from the entered data 114 of kudos within a particular range to generate an up to date visual representation 116. The Love Tank Meter 118 does not necessarily return to zero because the entered data 114 of kudos is separated into compiled data of kudos to determine the dial position of the Love Tank Meter 118. The compiled data is not necessarily zero for a new set of compiled data. Only a portion of the entered data 114 of kudos can be used to form the visual representation 116 of the Love Tank Meter, instead of all entered data 114.

Also, the entered data 114 may become stored data, which can be archived or compiled to establish a history of the relationship. The stored data is comprised of entered data 114 set by a different parameter, such as entered data 114 more than one year old. The stored data can also be displayed as graphs and charts to either or both individuals. The coordination of two profiles allows this meaningful interpretation of the entered data 114. One individual cannot re-set the count or re-do the parameters of the compiled data without cooperation of the other individual, which can reduce grudges and open agreement to allow bad spells in the relationship to pass.

In another variation, the entered data 114 may include self-reported data. A first individual may be able to enter data for behavior performed by the first individual. Even though the second individual has not entered data, the visual display of the first individual may be affected. In this variation, the individual gives kudos to himself or herself without the partner of the individual. The treatment of self-reported data will affect the visual display 116, although self-reported data may not have the same effect as the entered data 114 or compiled data by the partner of the individual.

The present invention remains compatible with existing technologies of social networks and smartphones. A further step of the invention is sharing, wherein there is an option of sharing the profile 102 with a third individual with a third profile or sharing displayed data 116 on social networking. In the mobile app example in FIG. 2, the Settings Menu may include a Sharing Tab to enable a sharing menu (not shown) with options to allow access by others. Another further step is entering status information 122, independent from entering data 116 related to the sub-profile 110. Each individual lists mood information, which can be displayed to the other individual. In the mobile app example in FIG. 2, the Settings Menu may include a FYEO tab 128 to enable a “for your eyes only” screen for posting messages and comments only viewable between the individual and the partner of the individual.

Other known features include push notifications. These notifications of activity of the other individual include posting comments to behavior tallied in the input variables 112, notice of visual representations 116, and sending messages. For the mobile app example in FIG. 2, notifications of a badge award or comments to a kudos can be sent to an individual by a push notification. Notification to the first and second individuals is another step of the present invention. The first and second individuals may receive reminders, tips, history, and recommendations for real life events. A feed-like display or private communication with only the two individuals further increases the communication to maintain a relationship, enabled by the innovative linking of the profiles and sub-profiles of the present invention.

The present invention further includes special push notifications based upon the entered data 114 in the input variables 112. For example, a special notification may be a reminder to perform a behavior to be tallied as entered data 114 for a particular input variable 112. More specifically, the special notification may be a reminder for affectionate touch to encourage a kudos for affectionate touch. The special notification is formed based upon the entered data 114, similar to the creation of the visual display 116. The entered data 114 can determine which special notifications will be sent to each individual. The compiled data of the entered data 114 in the input variables 112 can also be the basis for special notifications.

Another embodiment of the invention allows the individual to enter action data. Instead of relying upon the other individual to tally behaviors, the individual may count their own positive behaviors. The first individual enters data for each action by the first individual, and the second individual enters data for each action by the second individual. These actions are associated with an input variable 112 separate from the performed behaviors, although these actions still involve the relationship between the two individuals. For example, the actions may be comprised of response to trivia questions, completion of a challenge, or discussion of a big relationship issue, like deciding to have children. Action data affects the input variables 112 and can be positively shown in the visual presentation of displaying the data 116.

Some embodiments may include the further step of rewarding the two individuals. Based on the entered data of behaviors 116, matching data to sub-profiles 110, and action data, the two individuals can receive scores or points for performance. As the number of positive behaviors increase and as the data matches the weighted input variables 112, the individuals can be incentivized to maintain. For example, the present invention may award points for coupons for use in the real world or may provide price discounts for services of vendors in the dining and entertainment industries. These coupons and discounts may be related to particular input variables 112, such as dinner coupons for quality time, discounts to adult stores for sexual intimacy, and special prices for gifts. In the mobile app example of FIG. 2, the Settings menu screen may include a “Dates” tab 130, leading to a “Dates” menu with the listed options to vendors. The vendors may be organized by city, food type or even type of reward. The personal data 104 or the entered data 114 can be used to guide individuals by particular tendencies and toward targeted goods. The present invention may also use this information from entered data and stored data to provide notifications for reminders, tips, and recommendations.

Embodiments of the present invention provide a system and method to monitor status of a relationship between two individuals. The status of the relationship can be viewed as the number of positive behaviors performed by the first individual for the second individual and the number of positive behaviors performed by the second individual for the first individual. The number of positive behaviors may indicate that the individuals in the relationship are happy together because of the evidence of positive behaviors being performed and acknowledged. The present invention provides a data display to visually present this evidence for easy and convenient monitoring by the individuals. In alternate embodiments, the first and second individuals are in an employment relationship as employer and employee. The input variables can be customized and relate to job performance, such as attendance, meeting deadlines, and reporting safety violations. The visual display as a badges may increase communication between these individuals. The first and second individuals may be in a parent-child relationship or student-teacher relationship with different input variables set in the sub-profiles. The customization of the input variables allows various dimensions of any type of relationship to remain compatible with the present invention. Additionally, the first and second individuals may be in counseling, and the third party access to the present invention may be a therapist or counselor. The use of the present invention in therapy and couples counseling is another possible variation.

The system of the present invention may initially involve a mobile smartphone app. The incorporation of these devices, in addition to the internet and computer terminals increases the access and ease of entering data for the individuals. The instances of positive behaviors can be recorded and tallied in any location and at any time due to the smartphone device. The individuals are also able to monitor status of the relationship at all times and places.

Embodiments of the present invention rely on a computer program, which applies gaming principles to encourage positive behavior change of individuals in a romantic relationship. The counting of the number of behaviors, namely romantic behavior, and the various types of data displays creates a fun and interesting game context for maintaining a relationship. The additional counting of actions allows the individual to be pro-active as well. The tally can increase by positive actions of the individual in addition to the tally kept by the other individual. Trying to match the sub-profile of the other individual with the proper proportion of positive behaviors according to the weighted input variables can also be a stimulating exercise to increase the health of the relationship. Further examples include receiving badges or status recognition for meeting the needs of the other individual in the relationship, creating leaderboards in a statistics section, etc.

The visual presentation of the present invention allows positive affirmations between the two individuals in the relationship. Positive behavior change can be promoted by the active monitoring of the data. Self-tracking and self-monitoring of behaviors can also be performed by the individual. As the relationship develops and progress, each individual can view their active role, which may affect change and perceived accountability for their relationship.

An overall objective of the embodiments of the present invention is to provide a method to maintain a romantic relationship on multiple levels. In the context of a game, communication between two individuals increases, cooperation to achieve goals and receive rewards increases, and feedback for romantic behavior is visually presented. The present invention also encourages thinking and writing about the relationship, which may also be conducive to maintaining a healthy relationship.

The foregoing disclosure and description of the invention is illustrative and explanatory thereof. Various changes in the details of the described method can be made without departing from the true spirit of the invention.

I claim:

1. A method for monitoring status of a relationship between two individuals, the method comprising:
maintaining a first individual profile and a second individual profile in a computer network, wherein each profile comprises personal information, wherein the first profile is associated with the second profile, and wherein each profile is secured with password protection;
maintaining sub-profiles associated with each profile, wherein each sub-profile is comprised of input variables, and wherein each individual ranks said input variables by relative importance for only the sub-profile corresponding to the individual;
entering data of observed behaviors as entered data, said entered data being classified as related to at least one input variable by the first individual and entering data of observed behaviors as entered data, said entered data being classified as related to at least one input variable by the second individual; and
displaying a visual representation based upon entered data of the first individual to the second individual and creating a visual representation based upon entered data of the second individual to the first individual, wherein each visual representation is based upon entered data and the sub-profile of a respective individual.

2. The method for monitoring status of a relationship according to claim 1, wherein entered data is compiled by a set of parameters set by the first individual and the second individual to determine compiled data, wherein each visual representation is based upon said compiled data and the sub-profile of a respective individual.

3. The method for monitoring status of a relationship according to claim 1, wherein said personal information of each profile comprises photos, preference information, relationship status, partner identification, password setting, and a login setting.

4. The method for monitoring status of a relationship according to claim 1, wherein input variables of each sub-profile are set by the first and second individuals, said input variables being customized by mutual agreement between the first and second individuals.

5. The method for monitoring status of a relationship according to claim 1, wherein the step of maintaining sub-profiles comprises ranking input variables by weight of importance according to each individual, wherein the sub-profile of the first individual is comprised of a set of weighted input variables by the first individual, and wherein the sub-profile of the second individual is comprised of a set of weighted input variables by the second individual.

6. The method for monitoring status of a relationship according to claim 1, wherein the step of entering data comprises tallying each observed behavior and classifying each observed behavior as related to at least one input variable, wherein the first individual enters data for each behavior by the second individual, and wherein the second individual enters data for each behavior by the first individual.

7. The method for monitoring status of a relationship according to claim 1, wherein the step of displaying comprises creating a visual representation of the data for each behavior of the second individual to the first individual, and creating a visual representation of the data for each behavior of the first individual to the second individual.

8. The method for monitoring status of a relationship according to claim 7 wherein the visual representation is a badge image, said badge image corresponding to an input variable of said sub-profile, said visual representation being based on entered data and the input variable associated with said badge image.

9. The method for monitoring status of a relationship according to claim 8, herein a badge image of the first individual corresponds to achievement of the first individual related to an input variable of said sub-profile of the second individual, wherein a badge image of the second individual corresponds to achievement of the second individual related to an input variable of said sub-profile of the first individual.

10. The method for monitoring status of a relationship according to claim 7, wherein the visual presentation is a feed image, said feed image being organized chronologically.

11. The method for monitoring status of a relationship according to claim 7 wherein the visual representation is a meter image, said meter image being based on entered data and a corresponding sub-profile.

12. The method for monitoring status of a relationship according to claim 1, further comprising the step of:
rewarding the first individual and the second individual according to location of the two individuals and data of behaviors, said rewarding being comprised of providing price discounts for services, said services being supplied by vendors in dining and entertainment businesses, wherein said rewarding is determined by entered data by the first individual and weighted input variables of the sub-profile of the second individual and entered data by the second individual and weighted input variables sub-profile of the first individual.

13. The method for monitoring status of a relationship according to claim 1, further comprising the step of:
providing notifications to the first individual and the second individual based upon any one of the group consisting of reminders, tips, history, and recommendations.

14. The method of monitoring status of a relationship according to claim 12, wherein notifications are based upon entered data and sub-profiles of the individuals.

15. The method of monitoring status of a relationship according to claim 1, wherein each profile further comprises sharing options, said sharing options being comprised of at least a third party.

16. The method of monitoring status of a relationship according to claim 1, wherein each profile further comprises storage options, said storage options being comprised of entered data.

17. The method for monitoring status of a relationship according to claim 1, wherein the entered data is comprised of observed actions by each individual, wherein observed actions are tallied by each individual performing an observed action, wherein each observed action is associated with an input variable, and wherein each observed action is prompted to each individual.

18. The method for monitoring status of a relationship according to claim 17, wherein each observed action involves the relationship between the two individuals, each action being selected from a group consisting of a response to trivia question, completion of challenge, a discussion of relationship milestone issue.

19. A system for monitoring status of a relationship between two individuals, the system comprising:
a server comprising: a processor; a communications interface; and a memory for storing a profile of a first individual and a profile of a second individual, the first and second individuals being in a relationship, the profiles being associated with each other,
wherein the profile comprises personal information,
wherein the profile is secured with password protection,
wherein a sub-profile associated with the profile,
wherein said sub-profile is comprised of a set of input variables and wherein said input variables are weighted by each individual; and
a plurality of devices, corresponding to the individuals of each profile, each device being configured to connect the individuals via a computer network.

20. The system for monitoring status of a relationship according to claim 19, wherein said devices are comprised of at least one of a group consisting of mobile devices, computers, computer terminals, and smartphones.
